(19) United States
(12) Patent Application Publication
(10) Pub. No.: US 2026/0279617 A1
(43) Pub. Date: Sep. 17, 2026

(54) CORONA PROTECTION DEVICE

(71) Applicant: Hubbell Incorporated, Shelton, CT (US)

(72) Inventors: Temitope Dorothy Obielodan, Augusta, GA (US); Jeffrey Miller Butler, Martinez, GA (US)

(21) Appl. No.: 19/564,512

(22) Filed: Mar. 12, 2026

Related U.S. Application Data
(60) Provisional application No. 63/771,368, filed on Mar. 13, 2025.

(51) Int. Cl. H01B 5/00

(52) U.S. Cl. CPC H01B 5/004

(57) ABSTRACT

A corona protection device includes a first ring, a second ring, and a mounting bracket. The first ring and the second ring are connected to the mounting bracket. The first ring has a first outer diameter, and the second ring has a second outer diameter less than the first outer diameter. The rings can be positioned to provide an upper ring and a lower ring.

### RELATED APPLICATION(S)

This application is based on U.S. Provisional Application Serial No. 63/771,368, filed Mar. 13, 2025, the disclosure of which is incorporated herein by reference in its entirety and to which priority is claimed.

### FIELD

The present disclosure relates to power transmission line hardware, for example a corona protection device.

### BACKGROUND

Corona discharge is problematic in high voltage transmission systems and can occur in many hardware components, especially at the interface of components. One example of a component that can be prone to corona discharge are insulators. High voltage insulators serve as fundamental building blocks of electrical transmission infrastructure. Insulators mechanically support conductor cables while providing electrical isolation between these conductors and their supporting structures such as transmission towers. Without proper insulation, power transmission would be impossible, as electrical current would seek the path of least resistance through supporting structures, resulting in dangerous short circuits, equipment damage, and service interruptions. Insulators used in high voltage power transmission applications can be manufactured from various materials, with glass, ceramics, and composite polymers being the most common.

The effectiveness of an insulator stems from its non-conductive properties, wherein electrons within the insulating material resist flow under the influence of an electric field. This property is often referred to as having a high dielectric strength. Modern power transmission systems employ several types of insulators, each designed with specific characteristics to meet operational demands. These insulators must withstand not only electrical stresses but also mechanical loads, environmental factors, and thermal changes over decades of service.

The design of insulators must consider their operating environment, as adverse weather conditions can significantly impact performance. High-quality insulators possess substantial mechanical and electrical tension resistance along with remarkable durability to withstand environmental stresses. These properties ensure reliable operation even under extreme conditions such as heavy wind loads, ice accumulation, and temperature fluctuations that transmission lines routinely experience.

One common issue associated with insulators is the potential for corona discharge. Corona discharge is an electrical phenomenon that occurs when the electric field surrounding a conductor carrying high voltage ionizes the surrounding air, creating a conductive region that allows charge to continuously leak from the conductor. The process is visible as a characteristic bluish glow adjacent to pointed metal conductors carrying high voltages, emitting light through the same mechanism observed in gas discharge lamps.

To mitigate the detrimental effects of corona discharge, high voltage transmission systems utilize specialized hardware called corona protection devices. Among these, corona rings are particularly effective and widely implemented. Elimination of the corona discharge can protect the transmission lines and other hardware such as insulator assemblies against deterioration caused by these higher levels of electric stress.

### SUMMARY

Certain implementations are directed to a corona protection device for a power transmission system.

In certain configurations, a corona protection device includes a first ring, a second ring, and a mounting bracket. The first ring and the second ring are connected to the mounting bracket. The first ring has a first outer diameter and the second ring has a second outer diameter less than the first outer diameter.

In certain configurations, a corona protection device includes a first ring having a first ring body extending in a first arc and a second ring having a second ring body extending in a second arc. A mounting bracket extends across at least a portion of the first ring and the second ring. The first ring is connected to the mounting bracket at a first position. The second ring is connected to the mounting bracket at a second position spaced from the first position. The first ring has a first outer diameter and the second ring has a second outer diameter less than the first outer diameter.

In certain configurations, a corona protection device includes a first ring having a first ring body extending in a first arc and a second ring having a second ring body extending in a second arc. A mounting bracket extends across at least a portion of the first ring and the second ring. The first ring is connected to the mounting bracket at a first position. The second ring is connected to the mounting bracket at a second position spaced from the first position. The second ring is spaced from the first ring so that a lower plane of the second ring is substantially adjacent to an upper plane of the second ring.

### BRIEF DESCRIPTION OF THE DRAWINGS

The following drawings depict exemplary configurations and implementations of the inventive concepts of the disclosure.

FIG. 1 is a perspective view of a corona protection device.

FIG. 2 is a top view of FIG. 1.

FIG. 3 is a front view of FIG. 1.

FIG. 4 is a perspective view of the corona protection device connected to an insulator in a transmission system.

### DETAILED DESCRIPTION OF EXEMPLARY EMBODIMENTS

Certain implementations are directed to a corona protection device for use in a power transmission system. Corona discharge is a particular problem in high-voltage transmission. Corona discharge begins when the electric field at the surface of a conductor or hardware component exceeds the dielectric strength of the surrounding air, which is approximately 30 kV/cm at sea level pressure. This threshold decreases with altitude, making corona discharge more problematic at higher elevations where transmission lines often traverse. When the critical field strength is reached, naturally occurring free electrons in the air gain sufficient energy to collide with neutral air molecules, creating positive ions and additional free electrons in a process known as an electron avalanche.

Corona discharge typically forms at locations where the conductor or hardware geometry creates regions of high electric field concentration. These include sharp corners, projecting points, edges of metal surfaces, and small-diameter wires. At these highly curved regions, the potential gradient becomes significantly elevated compared to surrounding areas, causing localized breakdown of the air dielectric.

Corona discharge represents energy waste for utilities, as power that could be delivered to customers is instead dissipated into the atmosphere. The corona process also generates reactive gases such as ozone (O₃), nitric oxide (NO), nitrogen dioxide (NO₂), and, in the presence of water vapor, nitric acid (HNO₃)3. These compounds are not only environmentally problematic but also highly corrosive, gradually degrading nearby materials including the insulators themselves. This degradation can lead to premature failure of critical components and increased maintenance costs.

To help prevent corona discharge from forming, transmission systems may utilize corona protection devices such as corona rings. The primary function of a corona ring is to modify the electric field distribution around high voltage components, particularly at points where field concentration could otherwise lead to corona formation. By providing a smooth, curved surface with a relatively large radius, the ring reduces the maximum electric field gradient below the critical threshold where corona would occur. This mechanism effectively redistributes the electric stress more uniformly across the insulator surface and surrounding air.

Corona rings are typically manufactured from conductive metals such as copper, steel, or aluminum. The choice of material impacts both the electrical performance and the long-term durability of the ring. Copper offers excellent conductivity but at a higher cost, while aluminum provides a good balance of conductivity, weight, and corrosion resistance. The manufacturing precision of the corona ring is important, as surface irregularities or sharp edges on the ring itself could become initiation points for the very corona they are designed to prevent. In certain implementations, surface finishing process and coatings can be applied.

The geometric design of corona rings can be engineered to achieve optimal performance. Certain configurations can include a toroidal or partial-toroidal shaped body. Specific dimensions of the ring can be adjusted based on the system voltage and the geometry of the insulator assembly to achieve proper sizing for effective corona mitigation.

In transmission systems, corona rings can be strategically positioned at critical locations where electric field concentration is most severe. This typically includes the high-voltage end of insulator strings, around hardware fittings, and at conductor attachment points. For system voltages of 230kV and above, corona rings become important components of the system. At these voltage levels, the electric field strength without protection could easily exceed the corona threshold, leading to undesired continuous discharge activity.

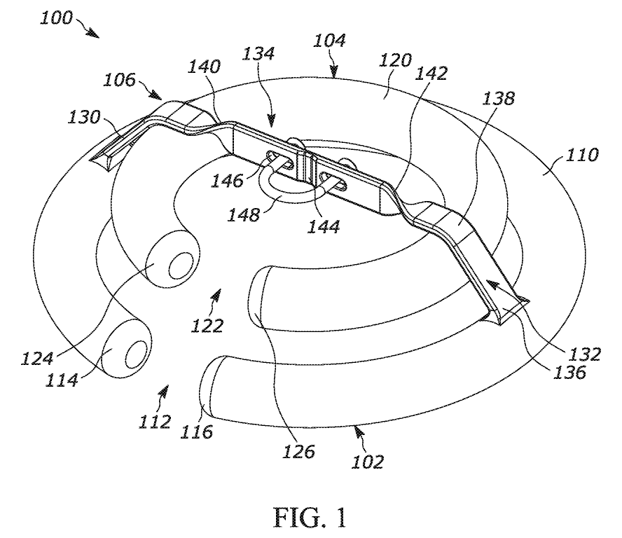

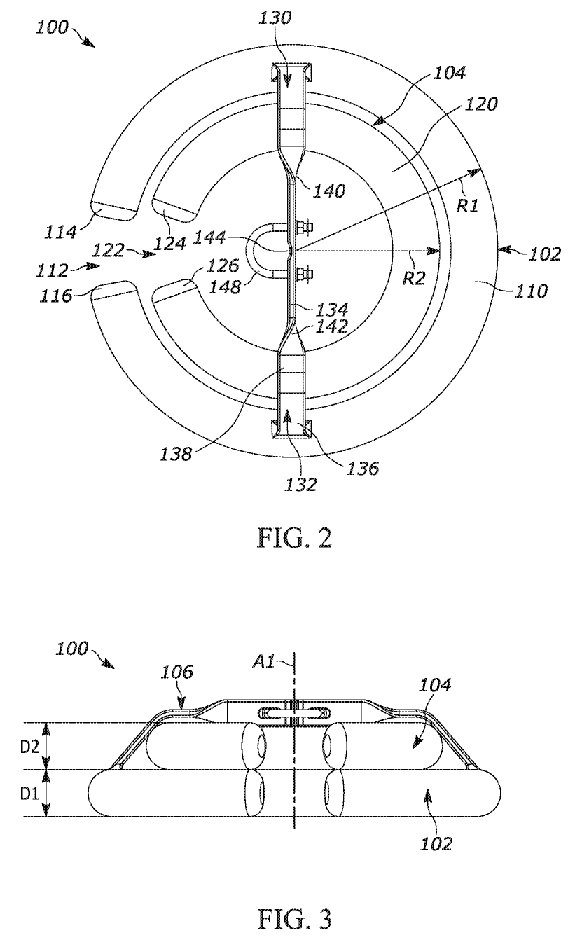

FIGS. 1-3 show an exemplary configuration of a corona protection device 100. The corona protection device includes an outer ring 102, an inner ring 104, and a mounting bracket 106. The outer ring 102 and the inner ring 104 are connected to the mounting bracket 106. In the illustrated configuration the outer ring 102 and the inner ring 104 are connected to the mounting bracket 106 through a joining process such as welding. Welding techniques including TIG, MIG, laser, electron beam, and/or resistance welding may be used. Alternatively, welding and other connecting techniques may be used alone or in combination such as separate components may be fixed using adhesives including but not limited to MMA, Acrylic and/or Epoxy such as EP 420 epoxy and/or removable fasteners including but not limited to bolts and nuts. The mounting bracket 106 can be used to secure the corona protection device in a transmission line system.

In certain configurations, the outer ring 102 has a partial toroid shape with a curved, cylindrical ring body 110. The ring body 110 can have a thickness defined by a first outer diameter D1. An outer edge of the ring body 110 extends around a central axis A1 in an arc with a first radius R1. The ring body 110 extends less than 360 degrees, with an opening 112. The opening 112 can be configured to receive an insulator for installation. The opening 112 can be at least partially defined by a first closed end 114 and a second closed end 116. In certain installations, the rings 102, 104 can be closed and installation can be achieved by placing insulators through the central opening of the rings.

The ends 114, 116 can have a reduced diameter from the ring body with smooth transitions and rounded edges. In certain configurations, the ends 114, 116 can be caps separately formed from the ring body 110 and attached thereto. In certain configuration, the end caps can be attached through welding, although other connections can be used. Other configurations can also utilize ends integrally formed with the ring body 110.

In certain configurations, the ends 114, 116 can have a frusto-conical configuration which tapers from the ring body 110 to the terminus of the ends 114, 116, although other shapes can be used. The frustum of the ends 114, 116 can extend through a plane non-parallel to each other. For example, the ends 114, 116 can extend at an oblique angle converging toward the center of the ring body 110. This can provide for easier installation of the protection device 100 on an insulator or other hardware. Other orientations can also be used.

In certain configurations, the inner ring 104 has a partial toroid shape with a curved, cylindrical ring body 120. The ring body 120 can have thickness defined by a second outer diameter D2. An outer edge of the ring body 120 extends around the central axis A1 in an arc with a second radius R2. The ring body 120 extends less than 360 degrees, with an opening 122. The opening 122 can be configured to receive an insulator for installation. The opening 122 can be at least partially defined by a first closed end 124 and a second closed end 126.

The ends 124, 126 can have a reduced diameter from the ring body with smooth transitions and rounded edges. In certain configurations, the ends 124, 126 can be caps separately formed from the ring body 110 and attached thereto. In certain configuration, the end caps can be attached through welding, although other connections can be used. Other configurations can also utilize ends integrally formed with the ring body 120.

In certain configurations, the ends 124, 126 can have a frusto-conical configuration which tapers from the ring body 120 to the terminus of the ends 124, 126, although other shapes can be used. The frustum of the ends 124, 126 can extend through a plane non-parallel to each other. For example, the ends 124, 126 can extend at an oblique angle converging toward the center of the ring body 120. This can provide for easier installation of the protection device 100 on an insulator or other hardware. Other orientations can also be used. In other configurations, other end styles, for example straight wall, cylindrical, or spherical end styles. Closed ends with sold rings can also be used.

In certain configurations, the mounting bracket 106 includes a first arm 130, a second arm 132, and a central portion 134 spanning the first arm 130 and the second arm 132. The mounting bracket 106 can be a single piece as shown, or multiple pieces connected together. In certain configurations, each of the arms 130, 132 includes a base 136 connected to the outer ring 102. A shoulder 138 can transition from the arms 130, 132 to the central portion 134. The shoulder 138 can be curved to provide a smooth transition and eliminate any sharp corners.

The central portion 134 includes a first twist 140 adjacent the first arm 130 and a second twist 142 adjacent the second arm 132. The first and second twist 140, 142 transitions the central portion 134 so that a major surface is extending in a plane non-parallel to the arms 130, 132. The central portion 134 can include a groove 144 configured to receive a portion of an insulator. Openings 146 can be positioned on each side of the groove 144. The openings 146 can receive a fastener, for example the U-bolt 148 shown in the illustrated example. Other types of fasteners can be used.

The mounting bracket 106 is adapted for use primarily with connection to an insulator. In the illustrated example the mounting bracket is formed from a unitary, substantially flat material. This can provide a better interface when connected to an insulator, for example a rounded end of an insulator. In other implementations, different types of mounting brackets can be used to connect to different hardware or support structures.

The outer ring 102 and inner ring 104 are connected to the mounting bracket 106. The connection can be through a joining process, such as a spot weld, or other types of connections can be used. The opening 112 of the outer ring 102 and the opening 122 of the inner ring 104 can be aligned. The outer ring 102 and inner ring 104 can be substantially coaxial about the first axis A1, although slight variations may result from standard tolerances or position of the mounting bracket 106. The inner ring 104 can be positioned vertically relative to the outer ring 102 so that a lower plane of the inner ring 104 is approximately aligned with an upper plane of the outer ring 102. This can be, for example, within a standard tolerance for attaching the rings, such as plus or minus 0.25 inches. In certain configurations the approximate alignment can be within a range of plus or minus 1 inch. In other configurations, the approximate alignment can be within a range of plus or minus 0.5 inches. In some implementations, approximate alignment within 0 to plus 0.5 inches vertical can provide enhanced corona dissipation. Other implementations can incorporate any combination of these ranges.

In certain configurations, the outer ring 102 can have an outer ring diameter of approximately 20 inches (R1 being equal to approximately 10) and the inner ring 104 can have an outer ring diameter of approximately 15 inches (R2 being equal to approximately 7.5). In most applications, the outer ring 102 will be larger than the inner ring 104. While any ring size can be used, results have shown that typical diameters can include 8”, 12”, 15”, and now 20” ring sizes. Any possible combination of sizes can be used and different sizes can be used depending on the application and the environment as needed. In certain configurations more than two rings can be used depending on the application.

In certain configurations, the ring bodies 110, 120 can be hollow cylinders. In one example, the ring bodies 110, 120 can have an inner diameter of approximately 2 inches and an outer diameter of approximately 2.375 inches. Although other configurations and thicknesses can be used.

In certain implementations, the outer ring 102 and the inner ring 104 can be made out of aluminum. For example, 6063 T4 aluminum, or other similar types of aluminum such as A56 T6 or LM6 aluminum can also be used. The ring bodies 110, 120 and the respective end caps can be made from the same material or different materials, for example different types of aluminum, in certain implementation depending on the structural, functional, and environmental requirements. Other types of conductive metals can also be used depending on the requirements.

In certain implementations, the material is cold formed, with the rings being bent from a cylindrical stock material to the appropriate size. Other formation processes including but not limited to casting, including but not limited to sand, investment, die, centrifugal, continuous, lost foam and/or vacuum casting; additive manufacturing processes; molding, including but not limited to metal injection molding, forging; extruding; rolling; drawing; molding, including metal injection molding, and machining including but not limited to CNC machining stock and any combination thereof, can also be used and can be dependent on the selected material. Surface finishing processes including polishing, smoothing, deburring, coating, etc., can also be applied.

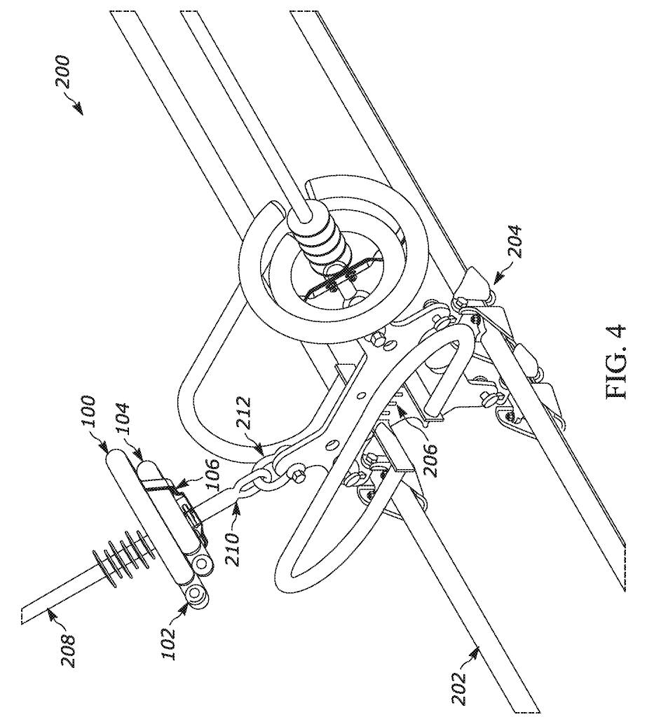

FIG. 4 shows an exemplary implementation of the corona protection device 100 used as part of a transmission system 200. The transmission system 200 includes three conductors 202 (two shown) supported by suspension clamps 204. The suspension clamps 204 are connected to a yoke plate 206. A pair of insulators 208 are connected to the yoke plate 206 at a first end via a chain eye end fitting 210 on an end of the insulator 208 and an anchor shackle 212 pivotally connected to the yoke plate 206 by a pin. The second end of the insulator 208 (not shown) can be connected to a transmission tower or other support hardware.

A corona protection device 100 can be connected to each of the insulators 208. The rings 102, 104 are positioned around the insulators and the fastener of the mounting bracket 106 is used to secure the corona protection device 100 to the insulator. The insulator can include a flange or other support structure to seat the fastener, for example the U-bolt 148. In certain installations, the rings 102, 104 can be positioned so that the openings 112, 122 face each other. Enhanced results can be achieved by this orientation although any orientation can be used.

The illustrated exemplary configuration of the corona protection device 100 has been found to be especially efficient in high-voltage AC and DC transmission lines. For example, the illustrated configuration of the corona protection device 100 can be used in over 500kV AC transmission lines and over 400kV DC transmission lines.

When the corona protection device 100 is installed, it alters how the electric field behaves around the insulator assembly 208. The large diameter and smooth surface of the rings 102, 104 create a more uniform field distribution, reducing the maximum field gradient below the corona inception threshold.

Corona protection devices are particularly important because corona discharge is not merely an energy loss phenomenon but also a progressive degradation mechanism. When corona occurs around insulators, it generates ultraviolet radiation and ozone that attack polymer materials, causing them to become brittle and develop microcracks over time. The nitric acid formed when nitrogen oxides combine with moisture can etch glass and ceramic surfaces, reducing their mechanical strength. By preventing corona formation, the rings significantly extend the service life of insulators.

The foregoing detailed description has been provided for the purpose of explaining the general principles and practical application, thereby enabling others skilled in the art to understand the disclosure for various configurations and implementations, and with various modifications as are suited to the particular uses contemplated. This description is not necessarily intended to be exhaustive or to limit the disclosure to what is disclosed. Any of the configurations and/or elements disclosed herein may be combined with one another to form various additional embodiments not specifically disclosed. Accordingly, additional configurations and implementations are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary embodiments of the present disclosure, and are not intended to limit the structure of the exemplary embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments. Unless specified or limited otherwise, the terms “mounted,” “connected,” “supported,” and “coupled” and variations thereof are used broadly and encompass both direct and indirect mountings, connections, supports, and couplings. The words “member,” “component,” “module,” “mechanism,” “element,” “device,” and the like are not a substitute for the word “means.” As such, no claim element should be construed as a means plus function unless the element is expressly recited using the phrase “means for.”

What is claimed:

1. A corona protection device comprising:
a first ring having a first ring body extending in a first arc;
a second ring having a second ring body extending in a second arc; and
a mounting bracket extending across at least a portion of the first ring and the second ring,
wherein the first ring is connected to the mounting bracket at a first position,
wherein the second ring is connected to the mounting bracket at a second position spaced from the first position,
wherein the first ring has a first outer diameter, and
wherein the second ring has a second outer diameter less than the first outer diameter.

2. The corona protection device of claim 1, wherein the first ring has a partial toroid configuration with an opening defined by a first end and a second end.

3. The corona protection device of claim 2, wherein a first endcap is connected to the first ring body at the first end and a second endcap is connected to the first ring body at the second end.

4. The corona protection device of claim 3, wherein the first endcap and the second endcap are oriented non-parallel to each other.

5. The corona protection device of claim 1, wherein the first ring is connected to the mounting bracket by a weld and the second ring is connected to the mounting bracket by a weld.

6. The corona protection device of claim 1, wherein the second ring is spaced from the first ring so that a lower plane of the second ring is approximately aligned with an upper plane of the first ring.

7. The corona protection device of claim 6, wherein the lower plane of the first ring is within a range of -1 in and 1 in of the upper plane of the second ring.

8. The corona protection device of claim 6, wherein the lower plane of the first ring is within a range of -0.2 in and 0.5 in of the upper plane of the second ring.

9. The corona protection device of claim 1, wherein the mounting bracket includes a first arm, a second arm, and a central portion.

10. The corona protection device of claim 9, wherein the central portion includes a first twist adjacent the first arm and a second twist adjacent the second arm.

11. A corona protection device comprising:
a first ring having a first ring body extending in a first arc;
a second ring having a second ring body extending in a second arc; and
a mounting bracket extending across at least a portion of the first ring and the second ring,
wherein the first ring is connected to the mounting bracket at a first position,
wherein the second ring is connected to the mounting bracket at a second position spaced from the first position, and
wherein the second ring is spaced from the first ring so that a lower plane of the second ring is approximately aligned with an upper plane of the first ring.

12. The corona protection device of claim 11, wherein the first ring has a first outer diameter and wherein the second ring has a second outer diameter less than the first outer diameter.

13. The corona protection device of claim 11, wherein the lower plane of the first ring is within a range of -0.2 in and 0.5 in of the upper plane of the second ring.

14. The corona protection device of claim 11, wherein the mounting bracket includes a first arm, a second arm, and a central portion.

15. The corona protection device of claim 14, wherein the central portion includes a first twist adjacent the first arm and a second twist adjacent the second arm.

16. An insulator and corona protection device comprising:
an insulator having a shaft with a first end, a second end, and a central portion extending between the first end and the second end;
a first ring having a first ring body extending in a first arc;
a second ring having a second ring body extending in a second arc; and
a mounting bracket extending across at least a portion of the first ring and the second ring,
wherein the first ring is connected to the mounting bracket at a first position,
wherein the second ring is connected to the mounting bracket at a second position spaced from the first position,
wherein the first ring has a first outer diameter,
wherein the second ring has a second outer diameter less than the first outer diameter, and
wherein the mounting bracket is connected to the insulator.

17. The corona protection device of claim 16, wherein the insulator is connected to the mounting bracket via a U-bolt.

18. The corona protection device of claim 16, wherein the second ring is positioned proximate the first end relative to the first ring.

19. The corona protection device of claim 16, wherein the second ring is spaced from the first ring so that a lower plane of the second ring is approximately aligned with an upper plane of the first ring.

20. The corona protection device of claim 16, wherein the first ring includes cold formed aluminum.
